(19) United States
(12) Patent Application Publication
(10) Pub. No.: US 2026/0122422 A1
(43) Pub. Date: Apr. 30, 2026

(54) METHOD FOR CONTROLLING AUDIO PLAYING, ELECTRONIC DEVICE, AND STORAGE MEDIUM

(71) Applicant: AAC Acoustic Technologies (Shanghai) Co., Ltd., Shanghai (CN)

(72) Inventors: Huan Ge, Shanghai (CN); Henglizi Zhang, Shanghai (CN); Lijian Ye, Shanghai (CN)

(21) Appl. No.: 19/000,576

(22) Filed: Dec. 23, 2024

Related U.S. Application Data
(63) Continuation of application No. PCT/CN2024/127342, filed on Oct. 25, 2024.

(51) Int. Cl. H04R 5/04; G06F 3/16

(52) U.S. Cl. CPC H04R 5/04; G06F 3/165; H04R 2499/13

(57) ABSTRACT

Embodiments of the disclosure relate to the technical field of acoustic control. A method for controlling audio playing, an electronic device and a storage medium are disclosed. The method is applied to an independent sound zone system and includes: determining, on receipt of an audio playing instruction, state levels of key states according to currently collected information about the key states, where the key states include a state of an occupant and a state of a vehicle that have an impact on an independent sound zone control algorithm adopted by the independent sound zone system; selecting a target filter from a pre-constructed filter database according to the state levels of the key states; and processing, by using the target filter, audio content indicated by the audio playing instruction. The present disclosure is at least beneficial to improving the control effect of independent sound zone control systems in different cases.

### TECHNICAL FIELD

Embodiments of the present disclosure relate to the technical field of acoustic control, and in particular, to a method for controlling audio playing, an electronic device, and a storage medium.

### BACKGROUND

In independent sound zone technology, a sound field control optimization algorithm is adopted to separately control input signals of speakers included in a control system, so that the audio content is played normally in a target acoustic bright zone and suppressed in a target acoustic dark zone. The control filter for regulating the input signals of the speakers is usually obtained by optimizing calculation based on the acoustic response of each speaker in the control system to the target acoustic zone.

In-car changes such as the movement and sitting posture of the occupants, and vehicle state such as opening and closing of windows will have a certain impact on the acoustic response of the controlled speaker to the target acoustic zone. Therefore, the control filter obtained by optimization calculation in a specific case may perform worse or even fail in other cases.

The usual approach to this problem is to add the impact of possible environmental changes on speaker response to the iterative optimization of the sound field control optimization algorithm to improve the robustness of the algorithm, thereby improving the overall performance of the algorithm under different environmental changes. However, this approach will lower the ultimate performance of the sound field control optimization algorithm in a special case, failing to achieve good performance in every case.

### SUMMARY

A method for controlling audio playing, an electronic device and a storage medium are provided according to embodiments of the present disclosure, which are at least beneficial to improving the control effect of independent sound zone control systems in various cases.

A method for controlling audio playing is provided according to an embodiment of the present disclosure. The method is applied to an independent sound zone system. The method includes: determining, on receipt of an audio playing instruction, state levels of key states according to currently collected information about the key states, where the key states include a state of an occupant and a state of a vehicle that have an impact on an independent sound zone control algorithm adopted by the independent sound zone system; selecting a target filter from a pre-constructed filter database according to the state levels of the key states; and processing, by using the target filter, audio content indicated by the audio playing instruction.

In some embodiments, the method further includes: before the determining, on receipt of an audio playing instruction, state levels of key states according to currently collected information about the key states, collecting states of the occupant and states of the vehicle in different cases, respectively calculating impacts of all the collected states on the independent sound zone control algorithm, and determining a state whose impact is greater than a threshold as the key state. The key state includes at least one of: a distance by which the occupant moves forward and backward, an angle at which a head of the occupant turns, a distance by which a height of the occupant changes, a switch states of a window, and a seat position.

In some embodiments, the method further includes: after the determining the state whose impact is greater than the threshold as the key state, dividing a variation range of each of the key states into at least one state sub-range, with impact of the key states in the same state sub-range on the independent sound zone control algorithm is within a preset range; and mapping each state sub-range to a state level.

In some embodiments, the method further includes: after the mapping each state sub-range to the state level, arbitrarily combining the key states at state levels respectively to obtain a plurality of state combinations; performing independent sound zone test modeling and optimization calculation on each of the state combinations using the independent sound zone control algorithm to obtain a control filter corresponding to each of the state combinations; and constructing the filter database with the control filters.

In some embodiments, determining the state levels of key states according to currently collected information about the key states includes: acquiring the key states in real time, and determining, on receipt of the audio playing instruction, the state level of the key state according to the state sub-range in which the key state currently acquired is located.

In some embodiments, the selecting the target filter from the pre-constructed filter database according to the state levels of the key states includes: determining a target state combination currently constituted by the key states according to the state levels of the key states; and reading a control filter corresponding to a state combination consistent with the target state combination from the filter database as the target filter.

In some embodiments, the method further includes: after the processing, by the target filter, the audio content indicated by the audio playing instruction, reading each of the key states in real time again and determining whether the state level of the key state has changed; in response to the state level of the key state having changed, determining the state level of the changed key state, newly selecting a target filter from the filter database according to state levels of the changed key states, and processing the audio content by the newly selected target filter that replaces the target filter; and still processing the audio content by the target filter in case of no change.

In some embodiments, the method further includes: before determining whether the state level of the key state has changed, determining whether there is audio content being currently played, determining whether the state level of the key state has changed is performed in case of audio content being currently played, and still processing the audio content by the target filter in case of no audio content being currently played.

An electronic device is provided according to some embodiments of the present disclosure. The electronic device includes: at least one processor and a memory in communication connection with the at least one processor. The memory stores instructions executable by the at least one processor. The instructions, when executed by the at least one processor, cause the at least one processor to implement the method for controlling audio playing.

A computer-readable storage medium is provided according to some embodiments of the present disclosure. The computer-readable storage medium stores a computer program. The computer program, when executed by a processor, causes the processor to implement the method for controlling audio playing.

The technical solutions in the embodiments of the present disclosure have at least the following advantages. Once an audio playing instruction from the user/vehicle is received, the state level of each key state is determined according to information currently acquired in real time about the key state that affects the independent sound zone control algorithm, a target filter corresponding to a combination of key states of the same or different state levels is selected from in a pre-constructed filter database, and audio content indicated by the audio playing instruction is processed by the target filter. That is, the filter most suitable for the current state can be selected to process the audio even though states of the occupant and the vehicle change dynamically, thereby automatically adapting the control strategy of the independent sound zone control system according to the changes in the occupant and the vehicle. Therefore, the sound zone control optimization algorithm can perform well in different cases, thereby improving the control effect of the independent sound zone control system in various cases.

### BRIEF DESCRIPTION OF THE DRAWINGS

One or more embodiments are illustrated by the figures in the corresponding drawings, and these exemplified descriptions do not constitute limitations on the embodiments. Elements with the same reference sign in the accompanying drawings are represented as similar elements, and the drawings in the accompanying drawings do not constitute scale restrictions unless otherwise stated.

FIG. 1 shows a flowchart of a method for controlling audio playing according to an embodiment of the present disclosure.

FIG. 2 shows a flowchart of a method for controlling audio playing according to another embodiment of the present disclosure.

FIG. 3 is a schematic structural diagram of an electronic device according to an embodiment of the present disclosure.

### DETAILED DESCRIPTION OF THE EMBODIMENTS

The following will be described in detail with reference to the accompanying drawings to illustrate the purpose, technical solutions and advantages of the embodiments of the present disclosure. However, those skilled in the art should appreciate that in the various embodiments of the present disclosure, many technical details are proposed in order to enable the reader to better understand the present disclosure. However, the technical solutions claimed in the present disclosure can be implemented even without these technical details and various changes and modifications based on the following embodiments. The following embodiments are divided for the convenience of description and should not constitute any limitation on the specific implementation of the present disclosure. The embodiments can be combined and referenced with each other without contradiction. It should be noted that the following contents are only implementation details provided for the convenience of understanding and are not necessary for the implementation of the technical solutions.

It can be known from the BACKGROUND section that, adding all environmental changes that may affect the speaker response to the iterative optimization of the sound field control optimization algorithm in order to adapt to environmental changes will result in lowered limit performance of the sound field control optimization algorithm in a special case, failing to stably obtain good performance in every case. Therefore, there is an urgent need for a method for controlling audio playing that can stably improve the control effect of an independent sound zone control system in various cases.

To solve the above problem, a method for controlling audio playing, an electronic device and a storage medium are provided according to embodiments of the present disclosure. The method for controlling audio playing in the present disclosure is applied to an independent audio zone system. Once an audio playing instruction from the user/vehicle is received, the state level of each key state is determined according to information currently acquired in real time about the key state that affects the independent sound zone control algorithm, a target filter corresponding to a combination of key states of the same or different state levels is selected from in a pre-constructed filter database, and audio content indicated by the audio playing instruction is processed by the target filter. That is, the filter most suitable for the current state can be selected to process the audio even though states of the occupant and the vehicle change dynamically, thereby automatically adapting the control strategy of the independent sound zone control system according to the changes in the occupant and the vehicle. Therefore, the sound zone control optimization algorithm can perform well in different cases, thereby improving the control effect of the independent sound zone control system in various cases.

The technical solutions of the present disclosure are described below. The division of the following embodiments is for the convenience of description and should not constitute any limitation on the specific implementation of the present disclosure. The various embodiments can be combined and referenced with each other under the premise of no contradiction.

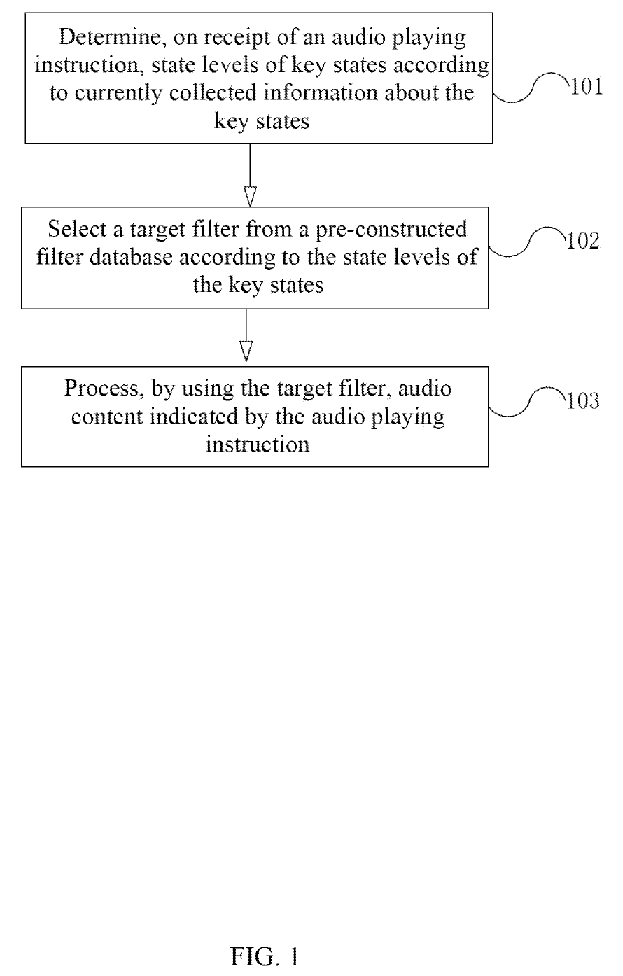

The method for controlling audio playing according to the embodiments of the present disclosure is applied to an independent sound zone system, which is a vehicle-mounted system referring to a sound system that can accurately control the transmission area of the audio. As shown in FIG. 1, the method for controlling the audio playing in the embodiments of the present disclosure includes the following operations 101 to 103.

In 101, state levels of key states are determined according to currently collected information about the key states on receipt of an audio playing instruction.

The key states include a state of an occupant and a state of a vehicle that have an impact on an independent sound zone control algorithm.

Specifically, independent sound zone technology, also known as directional sound, refers to an advanced sound field control technology that controls the audio content to be played in a designated area in the car, creating an independent and non-interfering audio space for each passenger in the car, giving each passenger a "private sound field" exclusive of him (her). Generally speaking, there are FM (Frequency Modulation), AM (Amplitude Modulation), USB-Music (USB audio), BT-Music (Bluetooth audio), BT-Call (Bluetooth phone), Chime (seat belt, turn signal prompt sound, etc.) and other audio sources inside the vehicle. Multiple audio sources may have the same or different usage cases, that is, the audio to be played by multiple audio sources may have different uses therefore are played to different target areas in the vehicle through independent audio zone systems. The independent audio zone system uses an independent audio zone algorithm to achieve independent audio zone control.

Due to changes inside the vehicle, such as the movement of passengers, different heights, body shapes and sitting postures of passengers, and changes in the vehicle state including seat adjustments, window openings and closings, etc., all will have a certain impact on the acoustic response of the controlled speaker to the target acoustic zone, which in turn will affect the independent sound zone control effect, that is, an impact on the independent sound zone control algorithm adopted by the independent sound zone system. Therefore, in this solution, the data of key states is acquired in real time by infrared sensors, radar sensors, force sensors, cameras, vehicle control systems, etc. The key states in the embodiments refer to the states of the occupants and the vehicle that have an impact on the control algorithm adopted by the independent sound zone system, and this application does not impose specific restrictions on them.

In the embodiments, the number of key states is at least one, and the embodiments do not impose specific restrictions on the number of key states. In order to effectively control the data scale of this solution, the impacts of relevant states on the control algorithm are determined separately with a control variable method. Occupant states and the vehicle states are sorted according to the degree of impact, and then the preset number of occupant states and vehicle states are selected as key states according to the sorting. The embodiments do not limit the method for determining the key states. Since the key state is changeable, the state level of each key state is determined based on the information about the key state. The state level can reflect the numerical state of the key state. For example, the head rotation angle is a key state and is divided into three state levels: level one, level two, and level three. Level one means that the head rotation angle ranges from 0 to 30 degrees. Level two means that the head rotation angle ranges from 30 degrees to 60 degrees. Level three means that the head rotation angle ranges from 60 degrees to 90 degrees. Therefore, the state level of the head rotation angle as a key state is directly determined according to the information about the head rotation angle currently acquired.

In 102, a target filter is selected from a pre-constructed filter database according to the state levels of the key states

Specifically, the independent sound zone control algorithm refers to designing a filter network for each speaker in a multi-speaker array and performing filtering operations on multi-channel input signals. In this process, the filter design goal in the independent sound zone control algorithm is to maximize the ratio of the sound energy of one or more specified areas to the sound energy of other areas, so as to achieve the purpose of regional control. Since changes in key states may affect the playing effect of the independent sound zone system controlled by the independent sound zone control algorithm, the corresponding target filter is directly selected from a pre-constructed filter database according to the state level of each current key state in this embodiment. The target filter corresponds to the state level of each current key state. It should be understood that the target filter is pre-designed by the independent zone control algorithm when the state levels of all current key states are the same and stored in the pre-constructed filter database. The pre-constructed filter database stores the corresponding filters of the key state at various state level, which can meet all the changes of the key state.

In 103, audio content indicated by the audio playing instruction is processed by the target filter.

Specifically, after the target filter is selected, the independent audio zone system uses the target filter to perform filtering operations on the multi-channel input signal. The multi-channel input signal is an audio signal of the audio content indicated by the audio playback instruction. This embodiment does not specifically limit the specific playing content of the audio content.

This embodiment is different from the related art in that once an audio playing instruction from the user/vehicle is received, the state level of each key state is determined according to information currently acquired in real time about the key state that affects the independent sound zone control algorithm, a target filter corresponding to a combination of key states of the same or different state levels is selected from in a pre-constructed filter database, and audio content indicated by the audio playing instruction is processed by the target filter. That is, the filter most suitable for the current state can be selected to process the audio even though states of the occupant and the vehicle change dynamically, thereby automatically adapting the control strategy of the independent sound zone control system according to the changes in the occupant and the vehicle. Therefore, the sound zone control optimization algorithm can perform well in different cases, thereby improving the control effect of the independent sound zone control system in various cases.

A method for controlling audio playing is provided according to another embodiment of the present disclosure, applied to an independent audio zone system. This embodiment is a supplement to the above embodiment, and includes the following operations.

In an example, before operation 101, the method includes: acquiring states of the occupant and states of the vehicle in different cases, respectively calculating impacts of all the acquired states on the independent sound zone control algorithm, and determining a state whose impact is greater than a threshold as the key state.

The key state includes at least one of: a distance by which the occupant moves forward and backward, an angle at which a head of the occupant turns, a distance by which a height of the occupant changes, a switch states of a window, and a seat position.

Specifically, the states of the occupant may be detected by a camera, an infrared sensor, a radar sensor, a force sensor, etc. The detected states of the occupant may include information such as the position in the vehicle of the occupant, the position of the head and torso, the size of the head, the direction in which the head faces, the rotation angle of the head, the position of the ears, etc. The vehicle states may be directly obtained through the vehicle system state feedback. The collected vehicle state may include whether the window is open, whether the door is open, the seat position in the car, the angle at which a seat has adjusted, the height by which the headrest has adjusted and other information. Due to the large number of occupant and vehicle states, a comprehensive analysis is conducted on all occupant and vehicle states (that can be represented by data), and the degree of impact of the states on the independent sound zone control algorithm are analyzed and calculated separately, from which a limited number of key states are screened out, in order to control the amount of data and ensure the control effect. The present disclosure does not impose any specific restrictions on the screening method. For example, a threshold is used for screening, and the occupant state and vehicle state whose impact on the independent sound zone control algorithm is greater than the preset threshold are screened out as key states for subsequent steps. The selected key states may include at least one of a distance by which the occupant moves forward and backward, an angle at which a head of the occupant turns, a distance by which a height of the occupant changes, a switch states of a window, and a seat position.

In an example, after the key states are determined, the method further includes: dividing a variation range of each of the key states into at least one state sub-range, with impact of the key states in the same state sub-range on the independent sound zone control algorithm is within a preset range; and mapping each state sub-range to a state level.

Since each key state constantly changes within its range of variation and the attributes of key states are different, the data for measuring the key states are also different, resulting in different ranges of variation of the key states. For example, when the key states include an angle at which a head of the occupant turns and a seat position, the angle ranges from 0 to 180°, and a distance by which the seat moves forward and backward ranges from 0 to 20 cm, etc. This application does not impose restrictions on this. In order to make the control of the independent sound zone system more accurate, the range of change of each key state is divided into at least one state sub-range in this embodiment. When a key state is within a state sub-range, the influence of the key state on the independent sound zone control algorithm is within a preset range. It can be considered that the degree of influence of the key state on the independent sound zone control algorithm is approximately the same when the key state is within a state sub-range. In addition, each state sub-range is mapped to a state level, so that each key state is divided into at least one level.\

On this basis, the determining state levels of key states according to currently collected information about the key states in operation 101 includes: acquiring the key states in real time, and determining, on receipt of the audio playing instruction, the state level of the key state according to the state sub-range in which the key state currently acquired is located.

That is, the state sub-range of each key state can be directly determined based on the information about the key state acquired in real time, and the state level of the key state can be further determined based on the state sub-range and the state level mapped to the state sub-range.

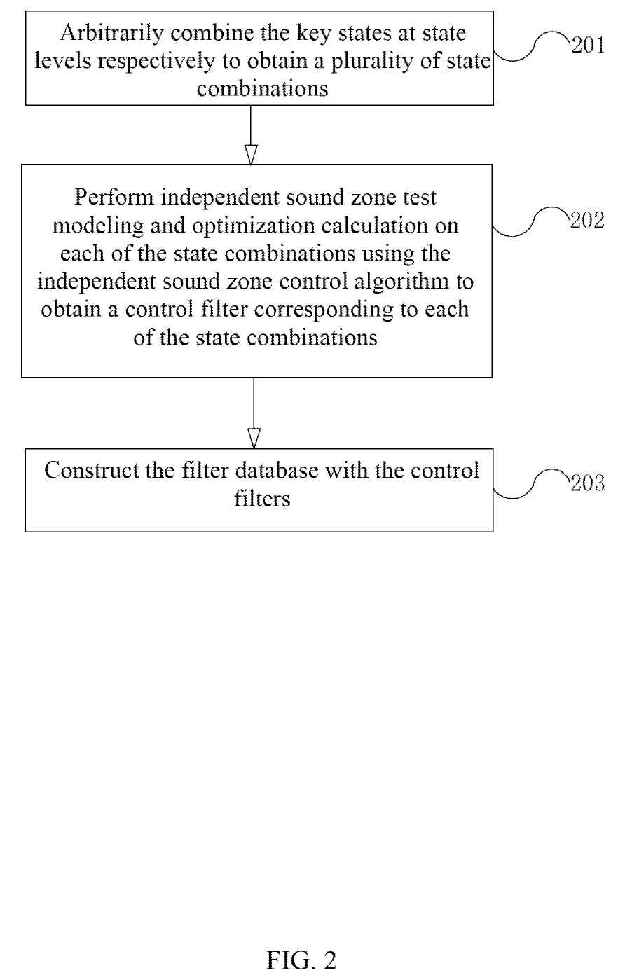

Accordingly, in an example, after the mapping each state sub-range to a state level, the method further includes the following operations 201 to 203 as shown in FIG. 2.

In 201, the key states are arbitrarily combined at state levels respectively to obtain multiple state combinations.

In 202, independent sound zone test modeling and optimization calculation are performed on each of the state combinations using the independent sound zone control algorithm to obtain a control filter corresponding to each of the state combinations.

In 203, the filter database is constructed with the control filters.

Specifically, after each key state is divided into at least one level, the key states at all state levels are arbitrarily combined to obtain various state combinations covering all combinations. For example, the total number of key states such as the distance by which the occupant moving forward and backward, the angle at which the head rotates, and the switch state of a window is 3, and the key states are recorded as S1, S2, and S3 respectively. For each key state, the impact of its variation range on the independent sound zone control algorithm is evaluated, and then the variation range of the key state is divided into one or more limited state sub-ranges. It should be noted that the state sub-ranges for those key state may be divided into same or different numbers, and this application does not impose restrictions on this. Assuming that the range of key state S1 is divided into three state sub-ranges and mapped to three state levels, the range of key state S2 is divided into six state sub-ranges and mapped to six state levels, and the range of key state S3 is divided into two state sub-ranges and mapped to two state levels. In this case, the three key states at each state level are combined, and there is a total of 3*6*2=36 state combinations.

The independent sound zone control algorithm refers to designing a filter for each speaker in a multi-speaker array so that the filter maximizes the ratio of the sound energy in one or more specified zones to the sound energy in other zones, so as to achieve the purpose of regional control. Therefore, the control filter corresponding to a state combination can be obtained by performing independent sound zone test modeling and optimization calculation with the independent sound zone control algorithm on the state combination. After obtaining the control filter corresponding to each state combination, a filter database is constructed with all the obtained control filters. Each control filter in the filter database uniquely corresponds to one state combination.

Operation 102 specifically includes: determining a target state combination currently constituted by the key states according to the state levels of the key states; and reading a control filter corresponding to a state combination consistent with the target state combination from the filter database as the target filter.

Specifically, after the state level of each key state is determined according to the currently acquired information upon receiving the audio playing instruction, the state combination formed by the key states is used as the target state combination. Since the control filter corresponding to each state combination has been pre-stored in the filter database, the control filter corresponding to the state combination consistent with the target state combination can be read from the filter database according to the target state combination, as the target filter to process the audio content indicated by the audio playback instruction.

In an example, after operation 103, the method further includes: reading each of the key states in real time again and determining whether the state level of the key state has changed; in response to the state level of the key state having changed, determining the state level of the changed key state, newly selecting a target filter from the filter database according to state levels of the changed key states, and processing the audio content by the newly selected target filter that replaces the target filter; and still processing the audio content by the target filter in case of no change.

Since the key state may change continuously, the key state may change significantly during the playing of the audio content if the audio content played as indicated by the audio playing instruction is of long duration. If the initially determined control filter is used throughout the entire process to process the audio content, poor results may result. Therefore, a preset duration may be set. When the preset duration elapsed since the time for processing the audio content using the initially determined control filter, all the key states are read again in real time to determine whether the state level of any key state has changed. This application does not impose any restrictions on the value of the preset duration.

It should be noted that the purpose of re-reading each key state in this embodiment is to obtain the change of a key state so as to update the control filter for processing the audio content when there is a change. This process requires that the audio content is continuously played. Therefore, before determining whether the state level of any key state has changed, it may also be determined whether there is audio content being played at the current moment. If there is audio content being played at the current moment, it is then determined whether the state level of any key state has changed. If the state level of a key state has changed, the state level of the key state after the change is determined, and the control filter for processing the audio content is updated using an operation similar to determining the target filter for the first time. That is, a target filter is newly selected from the filter database according to the changed state level of the key state. The newly selected target filter uniquely corresponds to the state combination corresponding to the changed state level of the key state. The newly selected target filter replacing the target filter processes the audio content, thereby realizing adaptive adjustment of the independent sound zone control system according to the change of the key state. If the state level of no key state changes, the audio content is continuously processed using the first determined target filter.

Different from the related art, this embodiment provides support for the independent sound zone system by selecting key states, dividing each key state into state levels, determining all state combinations of the key states at state levels, calculating the control filter corresponding to each state combination, and constructing a filter database. With the above method of the embodiments, the control strategy of the independent sound zone control system can be automatically adapted to changes in key states throughout audio playing, thereby improving the control effect of the independent sound zone control system in different cases.

The steps of the above method are divided only for the purpose of clear description. When implementing, the steps can be combined into one step or some steps can be split and decomposed into multiple steps, as long as they include the same logical relationship. All of which are within the scope of protection of the present disclosure. Adding insignificant modifications or introducing insignificant designs to the algorithm or process, but not changing the core design of the algorithm and process, are all within the scope of protection of the present disclosure.

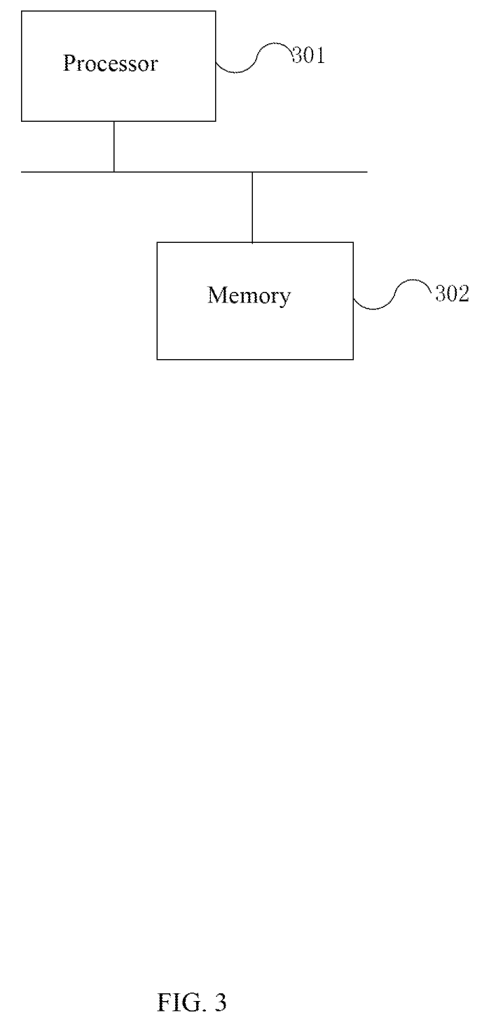

An electronic device is also provided according to another aspect of the embodiments of the present disclosure. As shown in FIG. 3, the electronic device includes: at least one processor 301 and a memory 302 in communication connection with the at least one processor 301. The memory 302 stores instructions that is executable by the at least one processor 301. The instructions, when executed by the at least one processor 301, cause the at least one processor 301 to implement the method for controlling audio playing described in any of the above method embodiments.

The memory 302 and the processor 301 are connected by a bus. The bus may include any number of interconnected buses and bridges. The bus connects various circuits of one or more processors 301 and the memory 302 together. The bus may also connect various other circuits such as peripherals, voltage regulators, and power management circuits together. These are well known in the art, and therefore are not further described herein. The bus interface provides an interface between the bus and the transceiver. The transceiver can be one element or multiple elements, such as multiple receivers and transmitters, providing a unit for communicating with various other devices on a transmission medium. The data processed by the processor 301 is transmitted on the wireless medium through the antenna, and further, the antenna also receives data and transmits the data to the processor 301.

The processor 301 is responsible for managing the bus and general processing, and can also provide various functions, including timing, peripheral interfaces, voltage regulation, power management and other control functions. The memory 302 stores data used by the processor 301 when performing operations.

A computer-readable storage medium is also provided according to another aspect of the embodiments of the present disclosure. The computer-readable storage medium stores a computer program, which implements the above method embodiment when executed by a processor.

That is, those skilled in the art can understand that all or part of the operations in the method can be completed by instructing the relevant hardware through a program. The program is stored in a storage medium, including a number of instructions to enable a device (which can be a single-chip microcomputer, a chip, etc.) or a processor to implement all or part of the operations of the method described in embodiments of the present disclosure. The aforementioned storage medium includes: a U disk, a mobile hard disk, a read-only memory (ROM), a random-access memory (RAM), a disk or an optical disk and other media that can store program code.

Those skilled in the art should appreciate that the above embodiments are merely specific embodiments for implementing the present disclosure, and various changes may be made thereto in form and detail without departing from the spirit and scope of the present disclosure in actual applications.

What is claimed is:

1. A method for controlling audio playing, applied to an independent sound zone system, wherein the method comprises:
determining, on receipt of an audio playing instruction, state levels of key states according to currently collected information about the key states, wherein the key states comprise a state of an occupant and a state of a vehicle that have an impact on an independent sound zone control algorithm adopted by the independent sound zone system;
selecting a target filter from a pre-constructed filter database according to the state levels of the key states; and
processing, by using the target filter, audio content indicated by the audio playing instruction.

2. The method of claim 1, further comprising, before the determining, on receipt of the audio playing instruction, the state levels of the key states according to the currently collected information about the key states:
acquiring states of the occupant and states of the vehicle in different cases, respectively calculating impacts of all the acquired states on the independent sound zone control algorithm, and determining a state whose impact is greater than a threshold as the key state, wherein the key state comprises at least one of: a distance by which the occupant moves forward and backward, an angle at which a head of the occupant turns, a distance by which a height of the occupant changes, a switch states of a window, and a seat position.

3. The method of claim 2, further comprising, after the determining the state whose impact is greater than the threshold as the key state:
dividing a variation range of each of the key states into at least one state sub-range, with impact of the key states in a same state sub-range on the independent sound zone control algorithm is within a preset range; and
mapping each state sub-range to a state level.

4. The method of claim 3, further comprising, after the mapping each state sub-range to the state level:
arbitrarily combining the key states at state levels respectively to obtain a plurality of state combinations;
performing independent sound zone test modeling and optimization calculation on each of the state combinations using the independent sound zone control algorithm to obtain a control filter corresponding to each of the state combinations; and
constructing the filter database with the control filters.

5. The method of claim 3, wherein determining the state levels of the key states according to the currently collected information about the key states comprises:
acquiring the key states in real time, and determining, on receipt of the audio playing instruction, the state level of the key state according to the state sub-range in which the key state currently acquired is located.

6. The method of claim 4, wherein selecting the target filter from the pre-constructed filter database according to the state levels of the key states comprises:
determining a target state combination currently constituted by the key states according to the state levels of the key states; and
reading a control filter corresponding to a state combination consistent with the target state combination from the filter database as the target filter.

7. The method of claim 1, further comprising, after processing, by using the target filter, the audio content indicated by the audio playing instruction:
re-reading each of the key states in real time again and determining whether the state level of the key state has changed;
in response to the state level of the key state having changed, determining the state level of the changed key state, newly selecting a target filter from the filter database according to state levels of the changed key states, and processing the audio content by the newly selected target filter that replaces the target filter; and
still processing the audio content by the target filter in case of no change.

8. The method of claim 7, further comprising, before determining whether the state level of the key state has changed:
determining whether there is audio content being currently played,
wherein determining whether the state level of the key state has changed is performed in case of audio content being currently played.

9. An electronic device, comprising:
at least one processor; and
a memory in communication connection with the at least one processor; wherein
the memory stores instructions executable by the at least one processor, and
the instructions, when executed by the at least one processor, cause the at least one processor to implement the method of claim 1.

10. The electronic device of claim 9, wherein the method further comprises, before the determining, on receipt of the audio playing instruction, the state levels of the key states according to the currently collected information about the key states:
acquiring states of the occupant and states of the vehicle in different cases, respectively calculating impacts of all the acquired states on the independent sound zone control algorithm, and determining a state whose impact is greater than a threshold as the key state, wherein the key state comprises at least one of: a distance by which the occupant moves forward and backward, an angle at which a head of the occupant turns, a distance by which a height of the occupant changes, a switch states of a window, and a seat position.

11. The electronic device of claim 10, wherein the method further comprises, after the determining the state whose impact is greater than the threshold as the key state:
dividing a variation range of each of the key states into at least one state sub-range, with impact of the key states in a same state sub-range on the independent sound zone control algorithm is within a preset range; and
mapping each state sub-range to a state level.

12. The electronic device of claim 11, wherein the method further comprises, after the mapping each state sub-range to the state level:
arbitrarily combining the key states at state levels respectively to obtain a plurality of state combinations;
performing independent sound zone test modeling and optimization calculation on each of the state combinations using the independent sound zone control algorithm to obtain a control filter corresponding to each of the state combinations; and
constructing the filter database with the control filters.

13. The electronic device of claim 11, wherein determining the state levels of the key states according to the currently collected information about the key states comprises:
acquiring the key states in real time, and determining, on receipt of the audio playing instruction, the state level of the key state according to the state sub-range in which the key state currently acquired is located.

14. The electronic device of claim 13, wherein selecting the target filter from the pre-constructed filter database according to the state levels of the key states comprises:
determining a target state combination currently constituted by the key states according to the state levels of the key states; and
reading a control filter corresponding to a state combination consistent with the target state combination from the filter database as the target filter.

15. The electronic device of claim 9, wherein the method further comprises, after processing, by using the target filter, the audio content indicated by the audio playing instruction:
re-reading each of the key states in real time again and determining whether the state level of the key state has changed;
in response to the state level of the key state having changed, determining the state level of the changed key state, newly selecting a target filter from the filter database according to state levels of the changed key states, and processing the audio content by the newly selected target filter that replaces the target filter; and
still processing the audio content by the target filter in case of no change.

16. The electronic device of claim 15, wherein the method further comprises, before determining whether the state level of the key state has changed:
determining whether there is audio content being currently played,
wherein determining whether the state level of the key state has changed is performed in case of audio content being currently played.

17. A non-transitory computer-readable storage medium storing a computer program, wherein
the computer program, when executed by a processor, causes the processor to implement the method of claim 1.

18. The non-transitory computer-readable storage medium of claim 17, wherein the method further comprises, before the determining, on receipt of the audio playing instruction, the state levels of the key states according to the currently collected information about the key states:
acquiring states of the occupant and states of the vehicle in different cases, respectively calculating impacts of all the acquired states on the independent sound zone control algorithm, and determining a state whose impact is greater than a threshold as the key state, wherein the key state comprises at least one of: a distance by which the occupant moves forward and backward, an angle at which a head of the occupant turns, a distance by which a height of the occupant changes, a switch states of a window, and a seat position.

19. The non-transitory computer-readable storage medium of claim 18, wherein the method further comprises, after the determining the state whose impact is greater than the threshold as the key state:
dividing a variation range of each of the key states into at least one state sub-range, with impact of the key states in a same state sub-range on the independent sound zone control algorithm is within a preset range; and
mapping each state sub-range to a state level.

20. The non-transitory computer-readable storage medium of claim 19, wherein the method further comprises, after the mapping each state sub-range to the state level:
arbitrarily combining the key states at state levels respectively to obtain a plurality of state combinations;
performing independent sound zone test modeling and optimization calculation on each of the state combinations using the independent sound zone control algorithm to obtain a control filter corresponding to each of the state combinations; and
constructing the filter database with the control filters.
